(19) United States
(12) Patent Application Publication
(10) Pub. No.: US 2013/0300610 A1
(43) Pub. Date: Nov. 14, 2013

(54) PORTABLE ELECTRONIC DEVICE, ANTENNA STRUCTURE AND RESONATOR UNIT THEREOF

(71) Applicant: WISTRON CORP., New Taipei City (TW)

(72) Inventors: Chen-Yu Chou, New Taipei City (TW); Kuo-Lin Tsai, New Taipei City (TW)

(73) Assignee: WISTRON CORP., New Taipei City (TW)

(21) Appl. No.: 13/659,857

(22) Filed: Oct. 24, 2012

(30) Foreign Application Priority Data
May 11, 2012 (TW) 101116789

(51) Int. Cl. H01Q 1/36

(52) U.S. Cl. 343/700 MS

(57) ABSTRACT

An antenna resonator unit is provided. The antenna resonator unit is adapted to be selectively connected to a first radiator or a second radiator, which includes a substrate and a resonator. The shape of the resonator is formed on the substrate, wherein the shape of the resonator is U-shaped, and includes a first end portion and a second end portion, wherein a ground point is formed on the first end portion, a radiator connection point is formed on the second end portion, and a feed point is disposed on the second end portion, wherein the radiator connection point is selectively connected to the first radiator or the second radiator.

### CROSS REFERENCE TO RELATED APPLICATIONS

This application claims priority of Taiwan Patent Application No. 101116789, filed on May 11, 2012, the entirety of which is incorporated by reference herein.

### BACKGROUND OF THE INVENTION

1. Field of the Invention

The present invention relates to an antenna resonator unit, and in particular relates to an antenna resonator unit adapted to be selectively connected to different radiators.

2. Description of the Related Art

Wireless communication functions have been popularly integrated into portable electronic devices, thereby requiring the implementation of antenna structures. However, the design of each portable electronic device is different, thus, the shape and available area for receiving antenna structures is variable. Accordingly, modifications may be required when manufacturing the antenna structures, such that cost and time increases.

### BRIEF SUMMARY OF THE INVENTION

In one embodiment of the invention, an antenna structure is provided. The antenna structure includes a resonator, a radiator, a feed line and a ground element. The shape of the resonator is U-shaped, comprising a first end portion and a second end portion, wherein a ground point is formed on the first end portion, a radiator connection point is formed on the second end portion, and a feed point is disposed on the second end portion. The radiator is coupling to the radiator connection point. The feed line is coupling to the feed point. The ground element is coupling to the ground point.

In another embodiment of the invention, an antenna resonator unit is provided. The antenna resonator unit is adapted to be selectively connected to a first radiator or a second radiator, which includes a substrate and a resonator. The shape of the resonator is formed on the substrate, wherein the shape of the resonator is U-shaped, comprising a first end portion and a second end portion, wherein a ground point is formed on the first end portion, a radiator connection point is formed on the second end portion, and a feed point is disposed on the second end portion, wherein the radiator connection point is selectively connected to the first radiator or the second radiator.

In further another embodiment of the invention, a portable electronic device is provided. The portable electronic device includes a housing and an antenna structure. The antenna structure is disposed in the housing. The antenna structure includes a resonator, a radiator, a substrate, a feed line and a ground element. The shape of the resonator is U-shaped, comprising a first end portion and a second end portion, wherein a ground point is formed on the first end portion, a radiator connection point is formed on the second end portion, and a feed point is disposed on the second end portion. The shape of the resonator is formed on the substrate. The radiator is coupling to the radiator connection point. The feed line is coupling to the feed point. The ground element is coupling to the ground point.

The antenna resonator unit of the embodiment of the invention has a decreased dimension, and can be disposed in various portable electronic devices. A designer only needs to design the radiator according to the shape of the inner space of the portable electronic device and does not need to redesign the entire antenna structure. The antenna resonator unit of the embodiment of the invention may be manufactured with decreased cost and time when compared to common techniques. The first and second radiators are designed according to different inner spaces of different portable electronic devices and can have different shapes, and can by manufactured in different ways. The first radiator and the second radiator can be formed by metal stamping, electroplating, circuit board printing or other ways.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the antenna resonator unit of an embodiment of the invention;

FIG. 2 shows the antenna resonator unit of the embodiment of the invention in an antenna structure of a portable electronic device; and

FIG. 3 shows a voltage standing wave ratio (VSWR) of the antenna structure of FIG. 2.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The main characteristic of the embodiment of the invention is that the resonator and the radiator of the antenna structure are designed respectively, and the shape of the resonator is designed to be commonly utilized with different radiators. Therefore, when designing the antenna structures for different portable electronic devices, only the radiators may need to be redesigned according to the shapes of the inner spaces of portable electronic devices. Thus, the design procedure of the antenna structures is simplified.

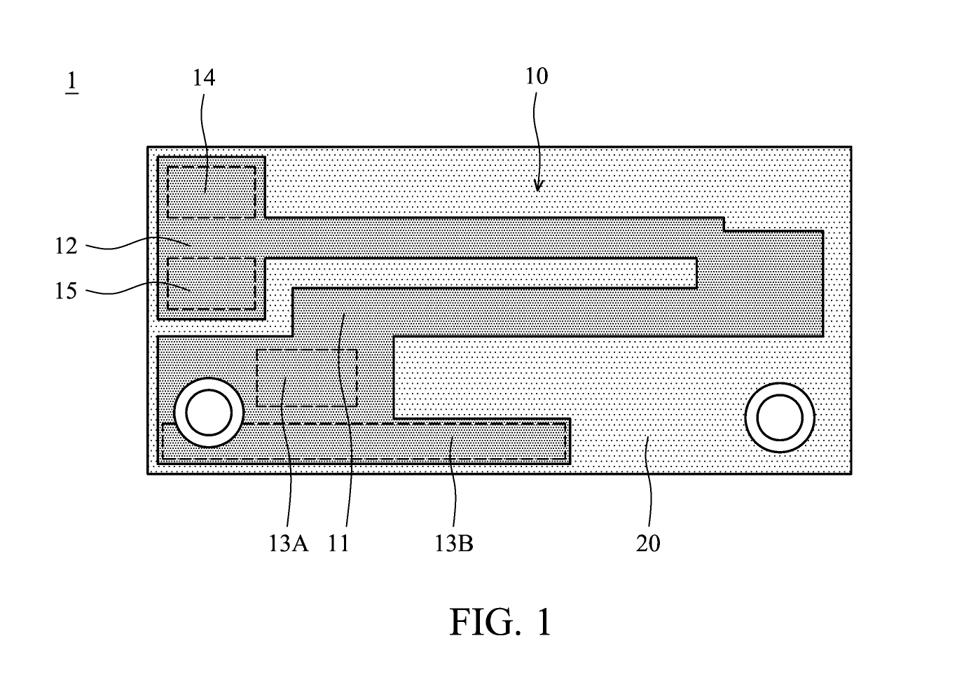

FIG. 1 shows an antenna resonator unit 1 of an embodiment of the invention, adapted to be selectively connected to a first radiator or a second radiator. The antenna resonator unit 1 comprises a resonator 10 and a substrate 20. The resonator 10 is formed on the substrate 20, wherein the resonator 10 is U-shaped, comprising a first end portion 11 and a second end portion 12, wherein a ground point 13A is formed on the first end portion 11, a radiator connection point 14 is formed on the second end portion 12, and a feed point 15 is disposed on the second end portion 12. The radiator connection point 14 is selectively connected to the first radiator or the second radiator.

The feed point 15 is disposed between the radiator connection point 14 and the ground point 13A.

In this embodiment, the second end portion 12 is T-shaped, and the feed point 15 and the radiator connection point 14 are respectively disposed on two free ends of the second end portion 12.

The resonator 10 can further comprise a ground portion 13B, connected to a ground element to increase a ground area of the antenna resonator unit.

In one embodiment, a resistance value of the resonator 10 is 50Ω.

In this embodiment, the resonator 10 can be mass manufactured and formed on the substrate 20 via a circuit board printing process, thus decreasing manufacturing costs. The resonator 10 can be connected to the radiator, the feed line and the ground element of the antenna structure by welding. The antenna resonator unit 1 of the embodiment of the invention has a decreased dimension, and can be disposed in various portable electronic devices. A designer only needs to design the radiator according to the shape of the inner space of the portable electronic device and does not need to redesign the entire antenna structure. The antenna resonator unit 1 of the embodiment of the invention may be manufactured with decreased cost and time when compared to common techniques. The first and second radiators are designed according to different inner spaces of different portable electronic devices and can have different shapes, and can by manufactured in different ways. The first radiator and the second radiator can be formed by metal stamping, electroplating, circuit board printing or other ways.

In a modified example, the substrate 20 can be omitted, and the resonator 10 is formed simply by metal stamping. The embodiments disclosed above do not limit the invention.

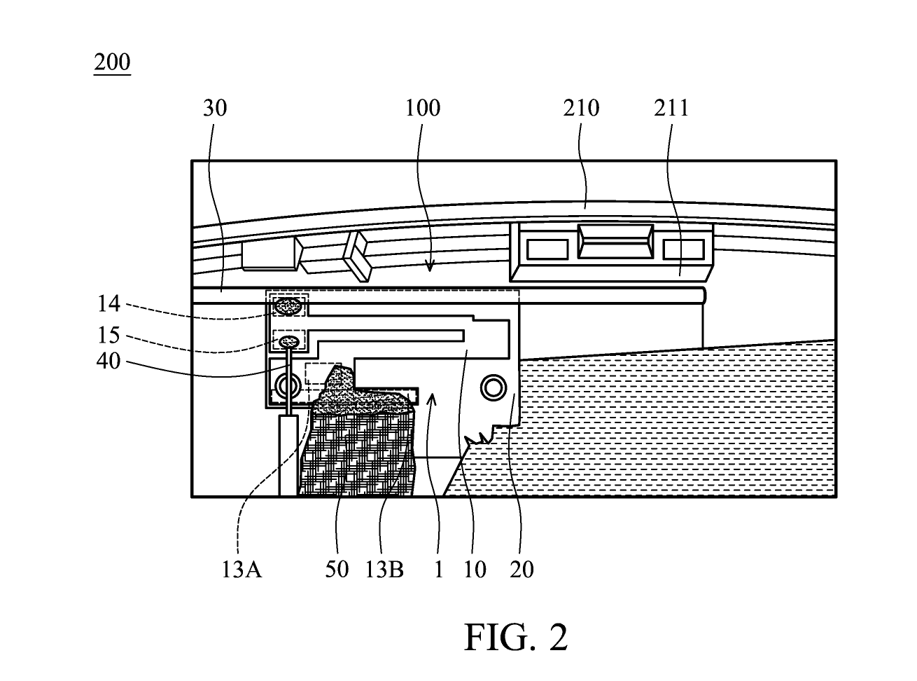

FIG. 2 shows the antenna resonator unit 1 of the embodiment of the invention in an antenna structure 100 of a portable electronic device 200. The portable electronic device 200 comprises a housing 210 and the antenna structure 100. The antenna structure 100 is disposed in the housing 210. The antenna structure 100 comprises the resonator 10, the substrate 20, a radiator 30, a feed line 40 and a ground element 50. The radiator 30 is coupled (weld) to the radiator connection point 14. The feed line 40 is coupled (weld) to the feed point 15. The ground element 50 is coupled (weld) to the ground point 13A and the ground portion 13B. The housing 210 comprises a side wall 211, and the radiator 30 extends in the inner space of the portable electronic device 200 along the side wall 211.

In this embodiment, the radiator 30 is a metal element. In the embodiment of FIG. 2, the antenna resonator unit of the embodiment of the invention can be placed in a proper position inside of the housing 210, and can be combined with different radiators to compose an antenna structure.

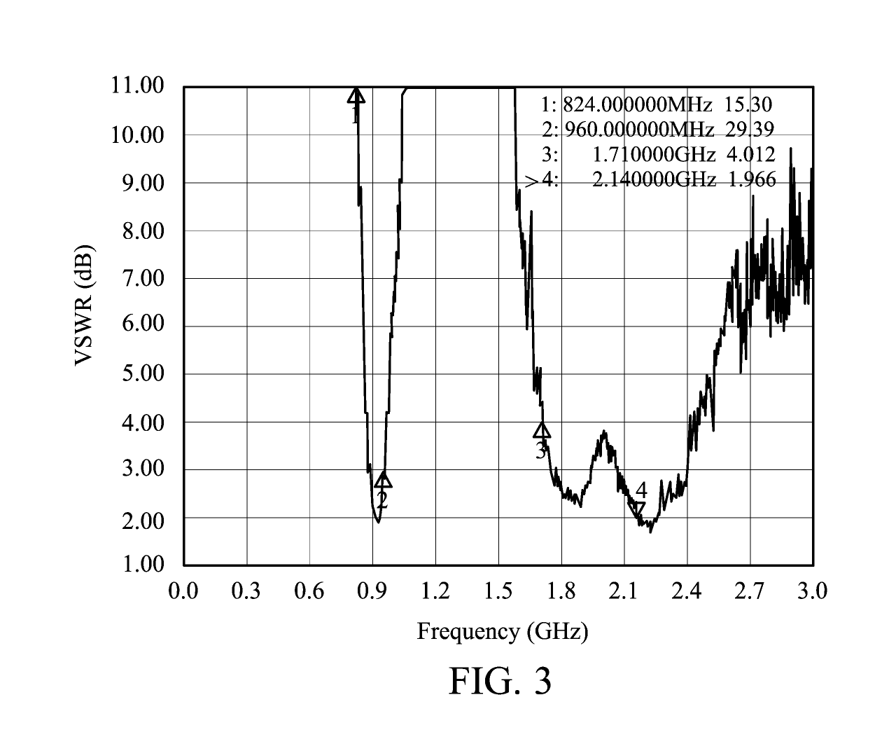

FIG. 3 shows a voltage standing wave ratio (VSWR) of the antenna structure 100 of FIG. 2, wherein the antenna structure 100 provides a fine transmission in a 3G operation band. In the embodiments of the invention, the operation bands disclosed are examples, and do not limit the invention.

The design procedure of the antenna structure of the embodiment of the invention is described as follows. First, the shape of the inner space inside the portable electronic device for containing the antenna structure is estimated. Then, a radiator is designed according the shape of the inner space and the predetermined antenna resonator unit. As mentioned above, utilizing the embodiment of the invention, a designer only needs to design the radiator according to the inner shape of the portable electronic device and does not need to redesign the entire antenna structure. The antenna resonator unit of the embodiment of the invention may be manufactured with decreased cost and time when compared to common techniques.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure, comprising:
a resonator, wherein the shape of the resonator is U-shaped, comprising a first end portion and a second end portion, wherein a ground point is formed on the first end portion, a radiator connection point is formed on the second end portion, and a feed point is disposed on the second end portion;
a radiator, coupling to the radiator connection point;
a feed line, coupling to the feed point; and
a ground element, coupling to the ground point.

2. The antenna structure as claimed in claim 1, wherein the feed point is disposed between the radiator connection point and the ground point.

3. The antenna structure as claimed in claim 2, wherein the second end portion is T-shaped, and the feed point and the radiator connection point are respectively disposed on two free ends of the second end portion.

4. The antenna structure as claimed in claim 1, further comprising a substrate, wherein the shape of the resonator is formed on the substrate.

5. The antenna structure as claimed in claim 1, wherein a resistance value of the shape of the resonator is 50Ω.

6. An antenna resonator unit, adapted to be selectively connected to a first radiator or a second radiator, comprising:
a substrate; and
a resonator, formed on the substrate, wherein the shape of the resonator is U-shaped, comprising a first end portion and a second end portion, wherein a ground point is formed on the first end portion, a radiator connection point is formed on the second end portion, and a feed point is disposed on the second end portion,
wherein the radiator connection point is selectively connected to the first radiator or the second radiator.

7. The antenna resonator unit as claimed in claim 6, wherein the feed point is disposed between the radiator connection point and the ground point.

8. The antenna resonator unit as claimed in claim 7, wherein the second end portion is T-shaped, and the feed point and the radiator connection point are respectively disposed on two free ends of the second end portion.

9. The antenna resonator unit as claimed in claim 6, wherein a resistance value of the shape of the resonator is 50Ω.

10. The antenna resonator unit as claimed in claim 6, wherein the first radiator or the second radiator is formed by metal stamping, electroplating, or circuit board printing.

11. The antenna resonator unit as claimed in claim 10, wherein a shape of the first radiator differs from a-shaped of the second radiator.

12. The antenna resonator unit as claimed in claim 10, wherein the first radiator and the second radiator are formed by different methods.

13. A portable electronic device, comprising:
a housing; and
an antenna structure, disposed in the housing, comprising:
a resonator, wherein the shape of the resonator is U-shaped, comprising a first end portion and a second end portion, wherein a ground point is formed on the first end portion, a radiator connection point is formed on the second end portion, and a feed point is disposed on the second end portion;
a substrate, wherein the shape of the resonator is formed on the substrate;
a radiator, coupling to the radiator connection point;
a feed line, coupling to the feed point; and
a ground element, coupling to the ground point.

14. The portable electronic device as claimed in claim 13, wherein the feed point is disposed between the radiator connection point and the ground point.

15. The portable electronic device as claimed in claim 14, wherein the second end portion is T-shaped, and the feed point and the radiator connection point are respectively disposed on two free ends of the second end portion.

16. The portable electronic device as claimed in claim 13, wherein the housing comprises a side wall, and the radiator is extended along the side wall.
